(19) United States
(12) Patent Application Publication
(10) Pub. No.: US 2004/0021649 A1
(43) Pub. Date: Feb. 5, 2004

(54) Method and apparatus for translating X, Y coordinates for a linear memory system

(76) Inventor: Keith Kejser, Westminster (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/211,326

(22) Filed: Aug. 2, 2002

(51) Int. Cl. G09G 5/00

(52) U.S. Cl. 345/204

(57) ABSTRACT

A device for translating a two dimensional address to a linear address is provided. In one embodiment the device is a display controller. The display controller includes address calculation circuitry that is configured to receive an X pixel coordinate and a Y pixel coordinate from a central processing unit. The address calculation circuitry is configured to translate the X pixel coordinate and the Y pixel coordinate to a linear address associated with a memory in communication with the display controller. Byte enable calculation circuitry is included. The byte enable calculation circuitry is configured to receive the linear address associated with the memory from the address calculation circuitry. The byte enable calculation circuitry is configured to enable a position of the linear address associated with the memory according to a color depth provided to the byte enable calculation circuitry.

### BACKGROUND OF THE INVENTION

1. Field of the Invention

This invention relates generally to computer graphics systems and more particularly to a method and apparatus to translate a two dimensional address to a linear address.

2. Description of the Related Art

Graphics on a display screen are shown on an X, Y axis. However, in order for a central processing unit (CPU) to write the image data, i.e., pixel data, the CPU has to write the data to a linear address in memory. That is the address must be translated from a two dimensional address to a one dimensional address. Currently, the calculation to convert or translate the address in memory of the pixel is performed in software.

When translating the two dimensional address through software a large amount of extra processing by the CPU is required. This extra processing slows system performance by interrupting the CPU and can result in delayed presentation of an image on a screen. For example, to write to a physical address in memory, software converts the two dimensional pixel address to a byte address of a single or double word line address. Byte enables are set to identify which pixels are written to or read from.

The conversion of the pixel X, Y coordinates to a linear address, such as a byte address, consumes an excessive amount of processing power. This is especially true for embedded systems used with handheld computer electronics such as personal digital assistants, web tablets, cellular phones, etc., that have limited resources to begin with. In addition, the display width and color depth must also be considered for the conversion in software. Thus, the software must perform two multiplication operations and an addition operation in order to convert the address. This process is computationally intensive for converting pixel addresses into linear byte addresses. Furthermore, the handheld devices are limited in terms of processing power, therefore, these computationally intensive processes can cause the device to stall, i.e., not be responsive.

As a result, there is a need to solve the problems of the prior art to provide a method and apparatus for efficiently translating two dimensional addresses to physical linear addresses without demanding extra processing by the CPU.

### SUMMARY OF THE INVENTION

Broadly speaking, the present invention fills these needs by providing a method and system for more efficiently displaying a computer generated image on a display screen. It should be appreciated that the present invention can be implemented in numerous ways, including as a process, a system, or a device. Several inventive embodiments of the present invention are described below.

In one embodiment a display controller is provided. The display controller includes address calculation circuitry that is configured to receive an X pixel coordinate and a Y pixel coordinate from a central processing unit. The address calculation circuitry is configured to translate the X pixel coordinate and the Y pixel coordinate to a linear address associated with a memory in communication with the display controller. Byte enable calculation circuitry is included. The byte enable calculation circuitry is configured to receive the linear address associated with the memory from the address calculation circuitry. The byte enable calculation circuitry is configured to enable a position of the linear address associated with the memory according to a color depth provided to the byte enable calculation circuitry.

In another embodiment, a device configured to display an image is provided. The device includes a central processing unit (CPU) and a random access memory (RAM). A display screen for displaying an image is included. A display controller in communication with the CPU, the RAM and the display screen is included. The display controller includes address calculation circuitry configured to receive an X pixel coordinate and a Y pixel coordinate from the CPU. The address calculation circuitry is configured to translate the X pixel coordinate and the Y pixel coordinate to a linear address associated with the RAM. Byte enable calculation circuitry configured to receive the linear address associated with the RAM from the address calculation circuitry is included. The byte enable calculation circuitry is configured to enable a position of the linear address associated with the RAM according to a color depth provided to the byte enable calculation circuitry, wherein the position is configured to store data associated with the image.

In yet another embodiment, a method for translating two dimensional address coordinates for a display to a linear address memory system is provided. The method initiates with converting a two dimensional pixel address to a byte code address. Then, at least one least significant bit of the byte code address is identified as a byte enable. Next, the byte enable is associated with a position of a linear address of memory.

In still yet another embodiment, a method for converting pixel coordinates to a linear byte address is provided. The method initiates with supplying a two dimensional pixel address having an X coordinate and a Y coordinate. Then, a color depth is associated with the two dimensional pixel address. Next, the two dimensional pixel address is transformed to a byte code address. Then, at least one least significant bit of the byte code address is selected as a byte enable. Next, the byte enable is associated with a location in a word line. Then, a number of bytes of the word line to store data associated with the pixel address is determined.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a high-level, simplified schematic diagram of components of a computing device in accordance with one embodiment of the invention.

FIG. 2 is a simplified schematic diagram of a LCD controller configured to convert X, Y coordinates to a linear address in accordance with one embodiment of the invention.

FIG. 3 is a schematic diagram of a LCD controller having circuitry configured to translate between pixel coordinates and linear memory addresses in accordance with one embodiment of the invention.

FIG. 4 is a more detailed schematic diagram of the pixel address logic of the LCD controller of FIG. 3 in accordance with one embodiment of the invention.

FIG. 5 is a schematic diagram illustrating the conversion of a two dimensional pixel address to a linear address in accordance with one embodiment of the invention.

FIG. 6 is a schematic diagram illustrating the conversion of a two dimensional pixel address to a linear address for a second quadrant of the embodiment of FIG. 5.

FIG. 7 is a schematic diagram illustrating the conversion of a two dimensional pixel address to a linear address for a third quadrant of the embodiment of FIG. 5.

FIG. 8 is a schematic diagram illustrating the conversion of a two dimensional pixel address to a linear address for a fourth quadrant of the embodiment of FIG. 5.

FIG. 9 is a schematic diagram illustrating the conversion of a two dimensional pixel address to a linear address where the color depth and the display width is increased from the embodiment of FIG. 5.

FIG. 10 is a schematic diagram illustrating the conversion of a two dimensional pixel address to a linear address where the display width is increased from the embodiment of FIG. 5.

FIG. 11 is a flowchart diagram of the method operations for converting pixel coordinates to a linear byte address in accordance with one embodiment of the invention.

### DETAILED DESCRIPTION OF THE PREFERRED EMBODIMENTS

An invention is described for an apparatus and method for converting a two dimensional pixel address to a linear address in memory. It will be obvious, however, to one skilled in the art, that the present invention may be practiced without some or all of these specific details. In other instances, well known process operations have not been described in detail in order not to unnecessarily obscure the present invention.

The embodiments of the present invention provide a method and apparatus for translating a pixel address, defined as X, Y coordinates, to a linear address in memory. As will be explained further below, a hardware implementation of translating the two dimensional pixel address to a linear address is provided. Accordingly, the hardware implementation includes circuitry defined by logic gates, transistors, etc., defined to perform conversion of the two dimensional address to a linear address. For example, many of the handheld electronic devices include embedded systems having display screens. The images displayed on the display screens are controlled by a controller, such as a liquid crystal display (LCD) controller. These handheld devices include devices, such as personal digital assistants (PDA), cellular phones, web tablets, pagers, and the like with limited processing power and battery life. Accordingly, the embodiments described below allow the central processing unit of these devices to offload some processing associated with the translation of a pixel address to a linear address. Desktop and lap top computers are not as limited in the processing power as compared to the portable handheld devices, however, the embodiments described herein can still be applied to these computers.

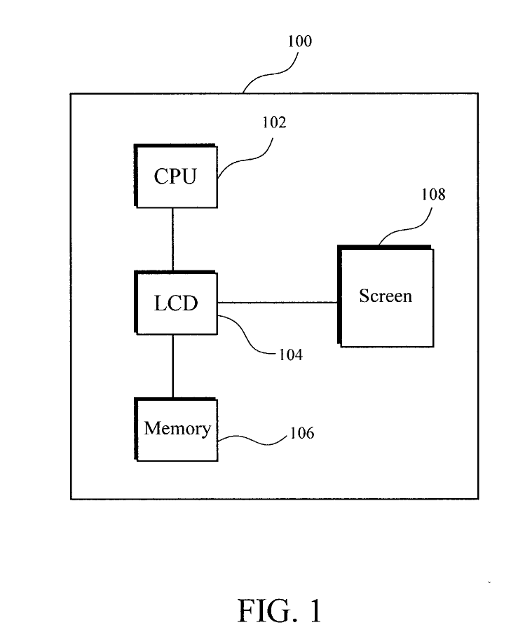

FIG. 1 is a high-level, simplified schematic diagram of components of a computing device in accordance with one embodiment of the invention. Computing device 100 includes central processing unit (CPU) 102 in communication with liquid crystal display (LCD) controller 104. LCD controller 104 is in communication with memory 106 and display screen 108. LCD controller 104 includes circuitry for translating a two dimensional pixel address associated with display screen 108 to a linear address in memory 106, as will be described in more detail below. Computing device 100 can be any of the handheld devices mentioned above or in general any portable electronic device having a display screen controlled by an LCD controller.

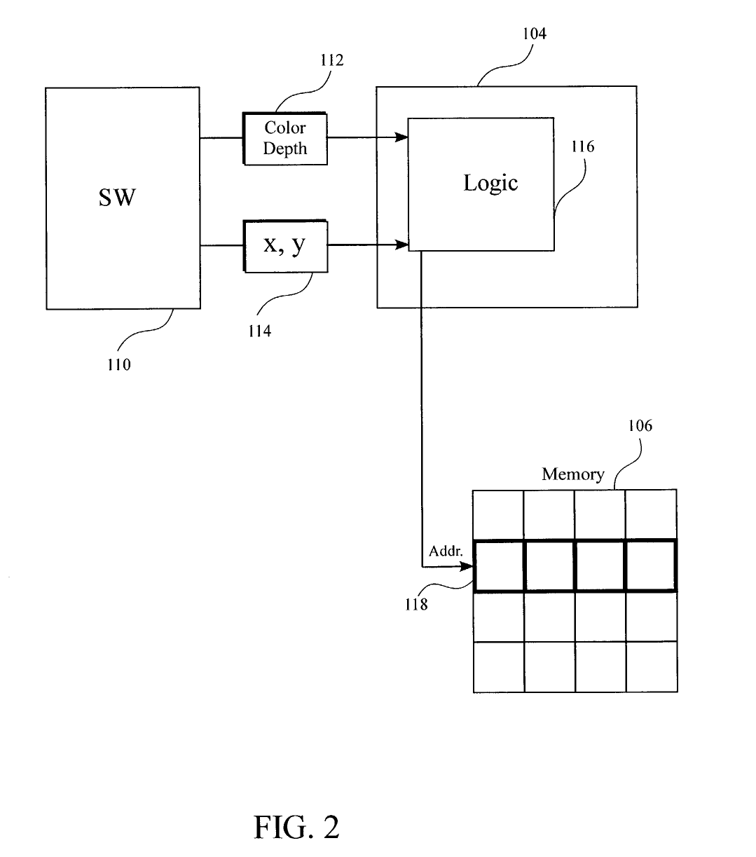

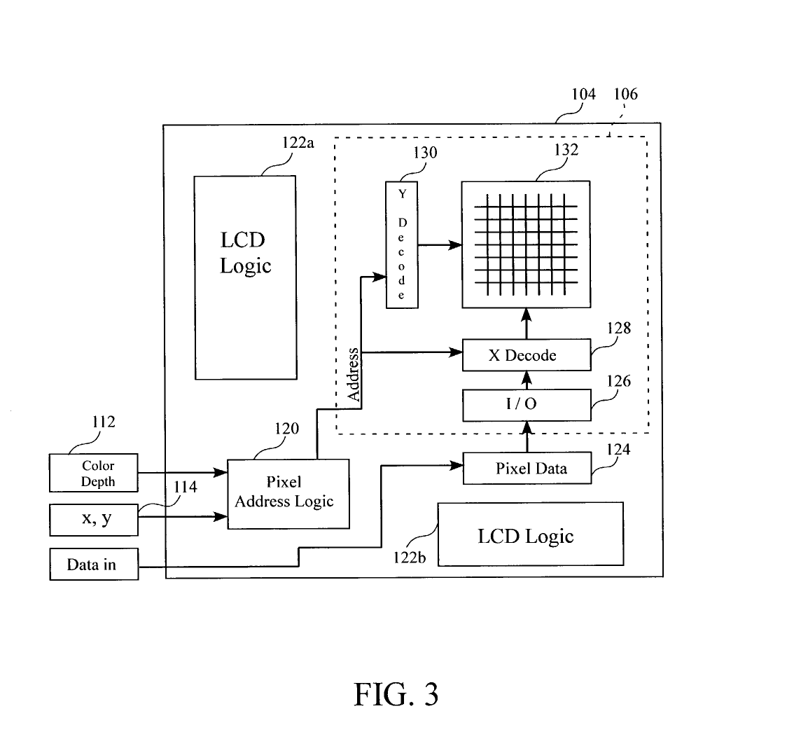

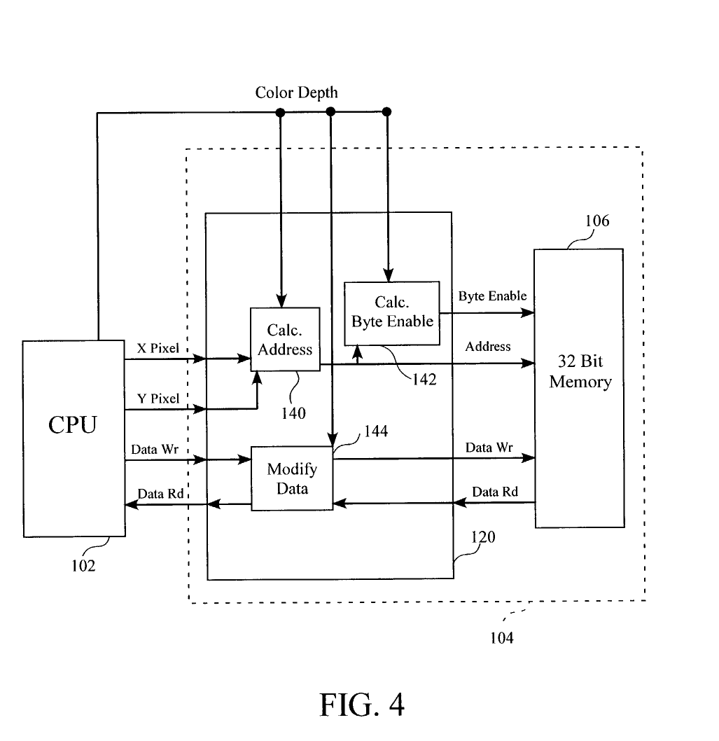

FIG. 2 is a simplified schematic diagram of a LCD controller configured to convert X, Y coordinates to a linear address in accordance with one embodiment of the invention. System memory 110 includes software code enabling the supply of the two dimensional pixel address as X, Y coordinates 114 to LCD controller 104. In addition, the software code executed on system memory 110 supplies color depth 112 to LCD controller 104. System memory 110 is associated with a microprocessor, such as a CPU, with reference to a computing device containing LCD controller 104. As used herein, color depth and color mode are interchangeable. It will be apparent to one skilled in the art that color depth 112 is defined as the amount of bits per pixel. The color depth of the pixel must be taken into account when converting a pixel address to a linear address. As is known, an eight bit pixel has one byte per pixel, a sixteen bit pixel has 2 bytes per pixel, a 32 bit pixel has 4 bytes per pixel, etc. LCD controller 104 includes logic region 116. Logic region 116 contains circuitry configured to convert X, Y address 114 to a linear address defining an address in memory 106 as will be explained further with reference to FIGS. 3 and 4. It should be appreciated that memory 106 is random access memory (RAM). In one embodiment, LCD controller 104 is an integrated circuit configured to provide the functionality described with reference to the embodiments described below.

It should be appreciated that the linear address defines an address in memory 106, such as region 118. In one embodiment, memory 106 is a 32 bit memory and the address for region 118 is a double word address, i.e., region 118 is a double word line. One skilled in the art will appreciate that a double word line includes 4 8-bit segments. While the embodiments described herein refer to a double word line in memory, it should be appreciated that a word line of any suitable size can also be used, such as a 16 bit, 32 bit, 64 bit, etc., word line. In one embodiment, color depth 112 supplies the information to determine a location in the double word line of region 118 for storage of the pixel data associated with coordinates 114. That is, the color depth identifies which 8 bit segment, of the four segment double word line, that the data associated with the pixel address will be written to or read from. For example, for a color depth of 1, i.e., 8 bits per pixel (bpp), the data would occupy one of the four 8-bit segments. In turn, for a color depth of 32 bpp, the data occupies all four 8-bit segments. In one embodiment, the amount of 8 bit segments associated with a color depth is hard coded into the circuitry of LCD controller 104. Therefore, once a color depth is known the amount of 8 bit segments to be associated with the color depth is determined.

FIG. 3 is a schematic diagram of a LCD controller having circuitry configured to translate between pixel coordinates and linear memory addresses in accordance with one embodiment of the invention. LCD controller 104 receives color depth 112 and X,Y coordinates 114 from the CPU. Pixel address logic 120 contains the circuitry for converting X, Y coordinate 114 into a linear memory address. As mentioned above, the pixel address logic includes circuitry, i.e., logic gates and transistors, arranged to perform the mathematical operations necessary to convert the two dimensional address to a linear address. This circuitry replaces the software based method of the prior art, therefore, the computationally intensive processing is offloaded from the CPU. The circuitry is configured on an integrated circuit chip and incorporated into LCD controller in one embodiment of the invention. In another embodiment, pixel address logic applies the following equation to the variables supplied, i.e., X, Y coordinates 114 and color depth 112:

Linear address=(X+Y*display width)*bytes per pixel

For the above equation X and Y are the X and Y coordinates supplied by the CPU, the display width is the width of the display screen in pixels supplied by the CPU, and the bytes per pixel is the color depth supplied by the CPU. One skilled in the art will appreciate that the display width can also be referred to the line offset. Thus, pixel address logic 120 is configured to perform the necessary mathematical operations for the above referenced equation to generate a resulting linear address. That is, pixel address logic includes the necessary transistor arrangement, i.e., logic gates, multipliers, adders, comparators, etc., to take the two dimensional address supplied and convert the two dimensional address to a linear address.

Continuing with FIG. 3, the address generated by pixel address logic 120 is supplied to memory 106. Memory 106 includes Y decode 130 and X decode 128, which provide a location within memory core 132. In one embodiment, memory 106 is a 32 bit memory that is configured to receive double word line addresses. Pixel data 124 corresponding to X, Y coordinates 114 is stored in the address generated by pixel address logic 120. One skilled in the art will appreciate that pixel data 124 is supplied to input/output (I/O) region 126 which in turn is in communication with X decode 128. LCD controller 104 includes LCD logic 122a and 122b which provides additional functionality, such as managing signals, controlling timing and interfaces with external components, etc.

FIG. 4 is a more detailed schematic diagram of the pixel address logic of the LCD controller of FIG. 3 in accordance with one embodiment of the invention. Here CPU 102 provides X pixel coordinate, Y pixel coordinate, and color depth to pixel address logic 120 of LCD controller 104. Pixel address logic 120 includes calculation address logic 140, calculation byte enable logic 142 and modify data logic 144. In one embodiment, calculation address logic 140 is configured to calculate the memory address for 32 bit memory 106 according to the X pixel, Y pixel and color depth set by CPU 102. That is, calculation address logic 140 contains circuitry designed to apply the equation for determining the linear address supplied above with reference to FIG. 3 to the X pixel, Y pixel and color depth set by CPU 102.

Calculation byte enable logic 142 of FIG. 4 includes circuitry configured to determine which of the four bytes in the double word line is written to in memory 106. Where memory 106 is a sixteen bit memory, i.e., single word line, calculation byte enable logic 142 includes circuitry configured to determine which of the two bytes in the single word line is written to in the memory. That is, the color depth and the address is supplied to calculation byte enable logic 142 and a byte enable signal is generated to identify which of the two or four bytes is written to in the word line. Modify data logic 144 includes circuitry configured to move pixel data associated with a corresponding X and Y coordinate to the correct byte of the 32 bits in memory 106. In addition, modify data logic 144 includes circuitry for moving the pixel data from 32 bit memory 106 to the correct byte for CPU 102. It should be appreciated that modify data logic 144 is executed in conjunction with a read or write operation.

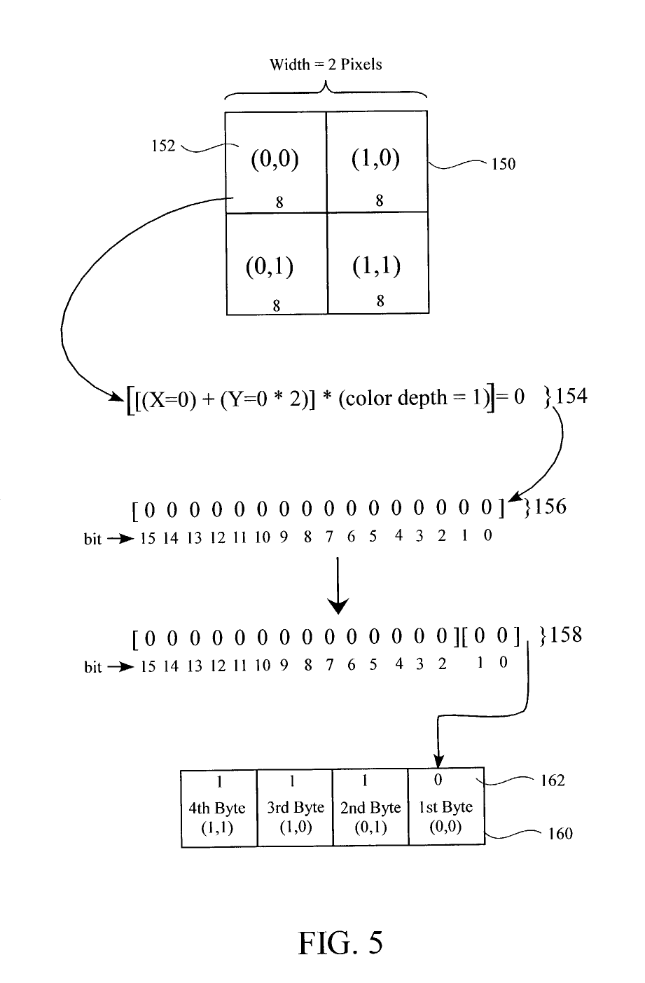

FIG. 5 is a schematic diagram illustrating the conversion of a two dimensional pixel address to a linear address in accordance with one embodiment of the invention. Display 150 includes four pixels having X, Y coordinates indicating the location of the pixel on the display. The display width associated with display 150 is two pixels. Each of the pixels has a color depth of 8 bpp, i.e., the color depth is 1. Described below are the operations involved in converting the two dimensional pixel address to a linear memory address. With respect to region 152 having X coordinate 0 and Y coordinate 0, the values for the X and Y coordinates are input into the equation described above with reference to FIG. 3. Equation 154 has the variables associated with region 152 input into the equation. As the X coordinate equals 0, the Y coordinate equals 0, the display width equals 2 and the color depth equals 1, the result generated equals zero. It should be appreciated that code executed in system memory supplies the variables to the hardware, such as the pixel address logic of FIGS. 3 and 4. Once the variables are supplied, the remaining operations are executed in hardware, thereby offloading the computationally intensive processes from the CPU.

Continuing with FIG. 5, the result from equation 154 is written as a byte code address. For example, byte code address 156 is a 16 bit binary number of the result of equation 154, which is 0. Thus, byte code address 156 is written as 16 zeros. In one embodiment, the software sees the memory as 16 bits deep by 8 bits wide, while the hardware, i.e., integrated circuit chip, sees the memory as 32 bits wide by 14 bits deep. Here, the 16 bit byte code address is transformed by truncating the two least significant bits, i.e., bit 0 and bit 1 for the double word line in memory. The least two significant bits are converted into four separate byte enable lines. In one embodiment, the byte enable lines are active low. The lower two bits of the byte address identify which bytes to enable in the 32 bit wide memory. For example, where the memory is a 32 bit memory having double word lines, then the lower two bits truncated from the byte code address identify which 8 bit location to store the pixel data in. Thus, bit 0 and bit 1 of line 158 indicate a byte enable for double word line 160 of the memory. That is, byte enable [00] indicates the first byte 162 of double word line 160. In one embodiment, bits 2-15 become the double word address. The four byte enable lines are represented by the logical value shown at the top of each byte of word line 160. The byte enable line for the first byte is a logical 0, where the remaining byte enable lines associated with bytes 2-4 are logical 1's, since the first byte is selected as the eight bit location to store the pixel data and the color depth is one byte.

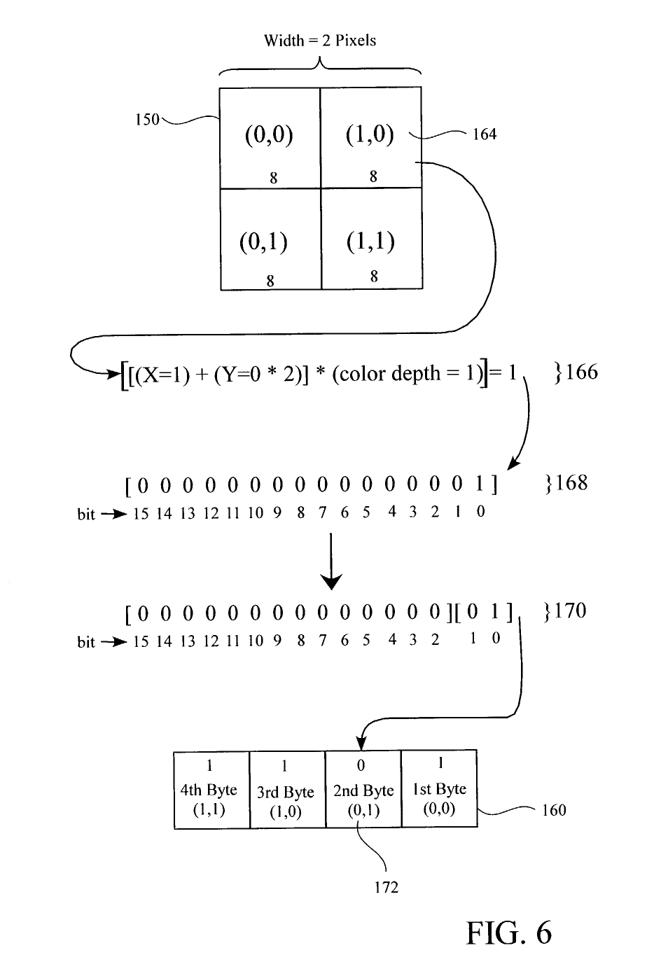

FIG. 6 is a schematic diagram illustrating the conversion of a two dimensional pixel address to a linear address for a second quadrant of the embodiment of FIG. 5. As mentioned above, display 150 includes four pixels having X, Y coordinates indicating the location of the pixel on the display. The display width associated with display 150 is two pixels. Each of the pixels has a color depth of 8 bpp, i.e., the color depth is 1. Described below are the operations involved in converting the two dimensional pixel address for the second quadrant to a linear memory address. With respect to region 164 having X coordinate 1 and Y coordinate 0, the values for the X and Y coordinates are input into the equation described above with reference to FIG. 3. Equation 166 has the variables associated with region 164 input into the equation. As the X coordinate equals 1, the Y coordinate equals 0, the display width equals 2 and the color depth equals 1, the result generated equals one. It should be appreciated that code executed in system memory supplies the variables to the hardware, such as the pixel address logic of FIGS. 3 and 4. Once the variables are supplied, the remaining operations are executed in hardware, thereby offloading the computationally intensive processes from the CPU.

Continuing with FIG. 6, the result from equation 166 is written as a 16 bit byte code address. For example, byte code address 168 is a 16 bit binary number of the result of equation 166, which is 1. Thus, byte code address 168 is written as one in binary form with zeros provided for bits 1-15. The 16 bit byte code address is transformed by truncating the two least significant bits, i.e., bit 0 and bit 1. The least two significant bits are converted into four separate byte enable lines. In one embodiment, the byte enable lines are active low. The lower two bits of the byte address identify which bytes to enable in the 32 bit wide memory. For example, where the memory is a 32 bit memory having double word lines, then the lower two bits truncated from byte code address 168 identify which 8 bit location to store the pixel data in. Thus, line 170 indicates a byte enable for double word line 160 of the memory. That is, byte enable [01] indicates the second byte 172 of double word line 160. The byte enable line for the second byte is a logical 0, where the remaining byte enable lines associated with bytes 1, 3 and 4 are logical 1's, since the second byte is selected as the 8 bit location to store the pixel data and the color depth is one byte.

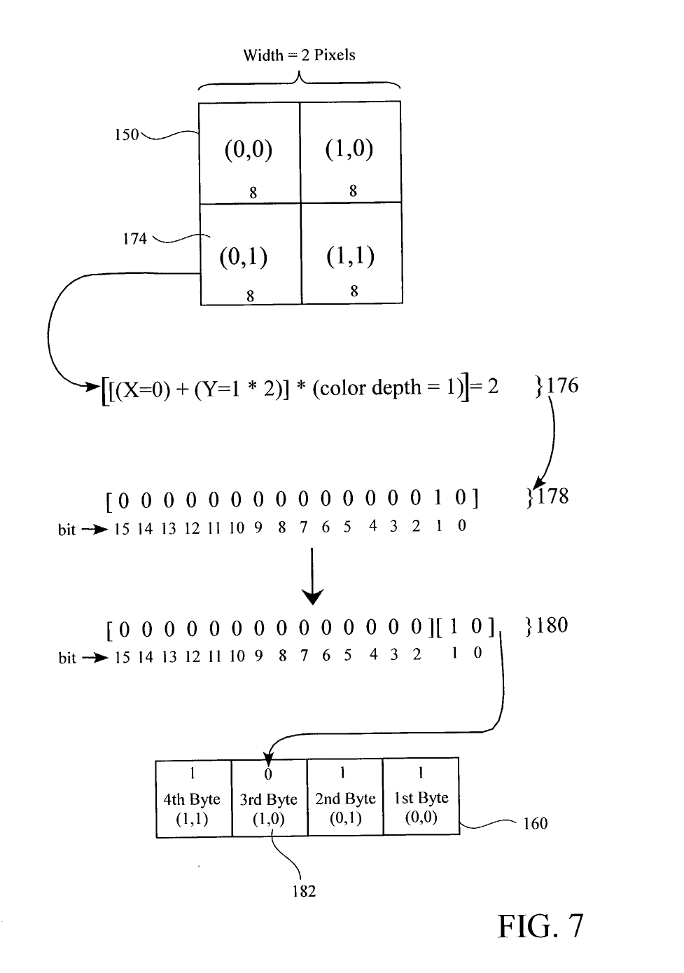

FIG. 7 is a schematic diagram illustrating the conversion of a two dimensional pixel address to a linear address for a third quadrant of the embodiment of FIG. 5. Described below are the operations involved in converting the two dimensional pixel address of the third quadrant to a linear memory address. With respect to region 174 having X coordinate 1 and Y coordinate 0, the values for the X and Y coordinates are input into the equation described above with reference to FIG. 3. Equation 176 has the variables associated with region 174 input into the equation. As the X coordinate equals 0, the Y coordinate equals 1, the display width equals 2 and the color depth equals 1, the result generated equals two. It should be appreciated that code executed in system memory supplies the variables to the hardware, such as the pixel address logic of FIGS. 3 and 4. Once the variables are supplied, the remaining operations are executed in hardware, thereby offloading the computationally intensive processes from the CPU.

Continuing with FIG. 7, the result from equation 176 is written as a byte code address. For example, byte code address 178 is a 16 bit binary number of the result of equation 176, which is 2. Thus, byte code address 178 is written as two in binary form with zeros provided from bits 2-15. In one embodiment, the software sees the memory as 16 bits deep by 8 bits wide, while the hardware, i.e., integrated circuit chip, sees the memory as 32 bits wide by 14 bits deep. Thus, the 16 bit byte code address is transformed by truncating the two least significant bits, i.e., bit 0 and bit 1. The least two significant bits are converted into four separate byte enable lines. In one embodiment, the byte enable lines are active low. The lower two bits of the byte address identify which bytes to enable in the 32 bit wide memory. For example, where the memory is a 32 bit memory having double word lines, then the lower two bits truncated from byte code address 178 identify which 8 bit location to store the pixel data in. Thus, line 180 indicates a byte enable for double word line 160 of the memory. That is, byte enable [10] indicates the third byte 182 of double word line 160. The byte enable line for the third byte is a logical 0, where the remaining byte enable lines associated with bytes 1, 2 and 4 are logical 1's, since the third byte is selected as the 8 bit location to store the pixel data and the color depth is one byte.

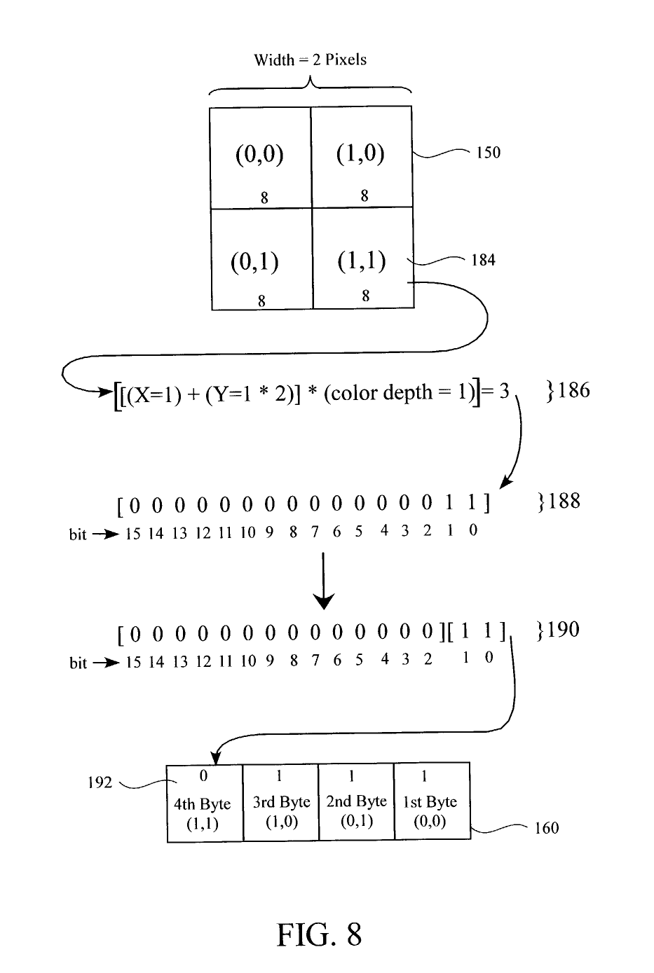

FIG. 8 is a schematic diagram illustrating the conversion of a two dimensional pixel address to a linear address for a fourth quadrant of the embodiment of FIG. 5. As mentioned above, display 150 includes four pixels having X, Y coordinates indicating the location of the pixel on the display and the display width associated with display 150 is two pixels. Each of the pixels has a color depth of 8 bpp, i.e., the color depth is 1. Described below are the operations involved in converting the two dimensional pixel address of the fourth quadrant to a linear memory address. With respect to region 184 having X coordinate 1 and Y coordinate 0, the values for the X and Y coordinates are input into the equation described above with reference to FIG. 3. Equation 186 has the variables associated with region 184 input into the equation. As the X coordinate equals 0, the Y coordinate equals 1, the display width equals 2 and the color depth equals 1, the result generated equals three. It should be appreciated that code executed in system memory supplies the variables to the hardware, such as the pixel address logic of FIGS. 3 and 4. Once the variables are supplied, the remaining operations are executed in hardware, thereby offloading the computationally intensive processes from the CPU.

Continuing with FIG. 8, the result from equation 186 is written as a 16 bit byte code address. For example, byte code address 188 is a 16 bit binary number of the result of equation 186, which is 3. Thus, byte code address 188 is written as 3 in binary form with zeros provided from bits 2-15. Then, the 16 bit byte code address is transformed by truncating the two least significant bits, i.e., bit 0 and bit 1. The least two significant bits are converted into four separate byte enable lines. In one embodiment, the byte enable lines are active low. The lower two bits of the byte address identify which bytes to enable in the 32 bit wide memory. For example, where the memory is a 32 bit memory having double word lines, then the lower two bits truncated from byte code address 188 identify which 8 bit location to store the pixel data in. Thus, line 190 indicates a byte enable for double word line 160 of the memory. That is, byte enable [11] indicates the fourth byte 192 of double word line 160. The byte enable line for the fourth byte is a logical 0, where the remaining byte enable lines associated with bytes 1-3 are logical 1's, since the fourth byte is selected as the 8 bit location to store the pixel data and the color depth is one byte.

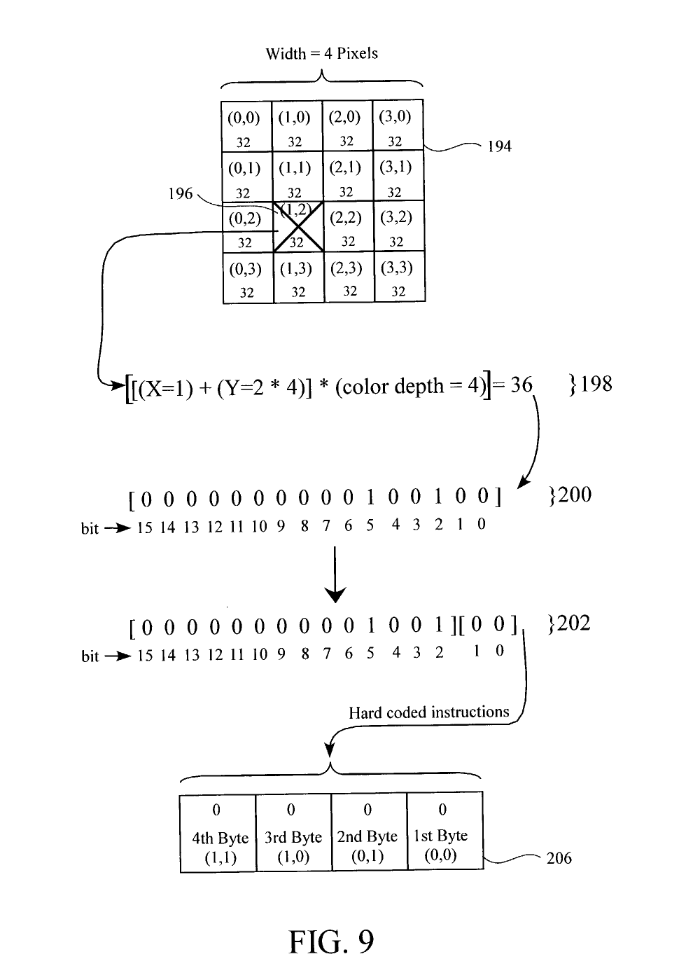

FIG. 9 is a schematic diagram illustrating the conversion of a two dimensional pixel address to a linear address where the color depth and the display width is increased from the embodiment of FIG. 5. Display 194 includes sixteen pixels having X, Y coordinates indicating the location of the pixel on the display. The display width associated with display 194 is four pixels. Each of the pixels has a color depth of 32 bpp, i.e., the color depth is 4 bytes. Described below are the operations involved in converting the two dimensional pixel address to a linear memory address. With respect to region 196 having X coordinate 1 and Y coordinate 2, the values for the X and Y coordinates are input into the equation described above with reference to FIG. 3. Equation 198 has the variables associated with region 196 input into the equation. As the X coordinate equals 1, the Y coordinate equals 2, the display width equals 4 and the color depth equals 4, the result generated equals 36. It should be appreciated that code executed in system memory supplies the variables to the hardware, such as the pixel address logic of FIGS. 3 and 4. Once the variables are supplied, the remaining operations are executed in hardware, thereby offloading the computationally intensive processes from the CPU.

Continuing with FIG. 9, the result from equation 198 is written as a 16 bit byte code address. For example, byte code address 200 is a 16 bit binary number of the result of equation 198, which is 36. Thus, byte code address 200 is written as 36 in binary form with zeros added from bits 6-15. In one embodiment, the software sees the memory as 16 bits deep by 8 bits wide, while the hardware, i.e., integrated circuit chip, sees the memory as 32 bits wide by 14 bits deep. Thus, the 16 bit byte code address is transformed by truncating the two least significant bits, i.e., bit 0 and bit 1. The least two significant bits are converted into four separate byte enable lines. The lower two bits of the byte address identify which bytes to enable in the 32 bit wide memory. For example, where the memory is a 32 bit memory having double word lines, then the lower two bits truncated from the byte code address identify which 8 bit location to store the pixel data in. Thus, bit 0 and bit 1 of line 202 indicate a byte enable for double word line 206 of the memory. However, since the color depth is four bytes, in one embodiment, hard coded instructions cause all four bytes of word line 206 to be selected. That is, the byte enable lines are all logical low values. It should be appreciated that for a color depth of four bytes, the formula of line 198 includes a multiplication operation by four. Thus, the least two significant bits are always 0,0 in the byte code address when multiplying by four. Additionally, all four bytes are selected for word line 206 by hard coded logic for selecting the four bytes. One skilled in the art will appreciate that a color depth of 2 bytes results in two 8 bit locations of a word line being selected through hard coded instructions.

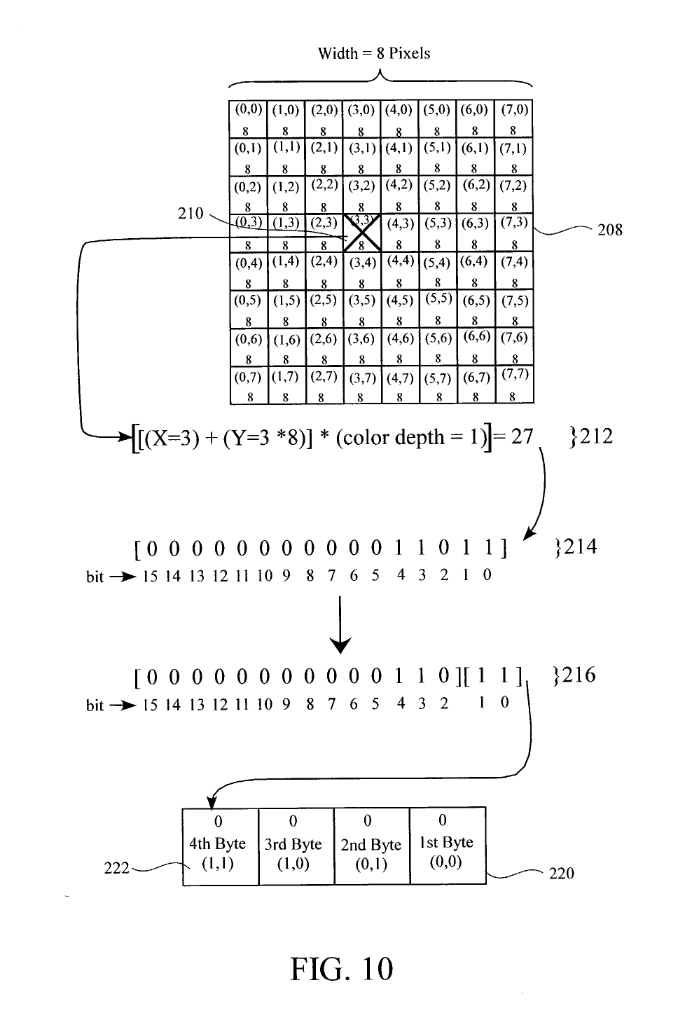

FIG. 10 is a schematic diagram illustrating the conversion of a two dimensional pixel address to a linear address where the display width is increased from the embodiment of FIG. 5. Display 208 includes 64 pixels having X, Y coordinates indicating the location of the pixel on the display. The display width associated with display 208 is eight pixels. Each of the pixels has a color depth of 8 bpp, i.e., the color depth is 1. Described below are the operations involved in converting the two dimensional pixel address to a linear memory address. With respect to region 210 having X coordinate 3 and Y coordinate 3, the values for the X and Y coordinates are input into the equation described above with reference to FIG. 3. Equation 212 has the variables associated with region 210 input into the equation. As the X coordinate equals 3, the Y coordinate equals 3, the display width equals 8 and the color depth equals 1, the result generated equals 27.

Continuing with FIG. 10, the result from equation 212 is written as a 16 bit byte code address. For example, byte code address 214 is a 16 bit binary number of the result of equation 198, which is 27. Thus, byte code address 214 is written as 27 in binary form with zeros added from bits 5-15. In one embodiment, the software sees the memory as 16 bits deep by 8 bits wide, while the hardware, i.e., integrated circuit chip, sees the memory as 32 bits wide by 14 bits deep. Thus, the 16 bit byte code address is transformed by truncating the two least significant bits, i.e., bit 0 and bit 1. The least two significant bits are converted into four separate byte enable lines. That is, the lower two bits of the byte address identify which bytes to enable in the 32 bit wide memory. For example, where the memory is a 32 bit memory having double word lines, then the lower two bits truncated from the byte code address identify which 8 bit location to store the pixel data in. Thus, bit 0 and bit 1 of line 216 indicate a byte enable for double word line 220 of the memory. That is, byte enable [11] indicates the fourth byte 222 of double word line 220.

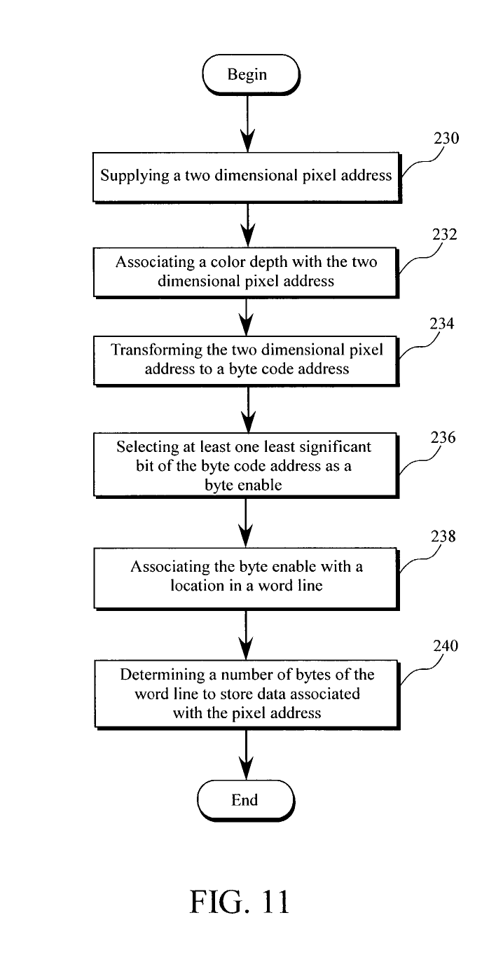

FIG. 11 is a flowchart diagram of the method operations for converting pixel coordinates to a linear byte address in accordance with one embodiment of the invention. The method initiates with operation 230 where a two dimensional pixel address is provided. Here, the pixel address can have an X coordinate and a Y coordinate associated with a display screen. The method advances to operation 232 where a color depth is associated with the two dimensional pixel address. The color depth identifies the number of bytes per pixel, i.e., 8 bpp corresponds to a color depth of 1, 16 bpp corresponds to a color depth of 2, and so on. The method then moves to operation 234 where the two dimensional pixel address is transformed to a byte code address. For example, the equation described above with reference to FIG. 3 can be applied to the pixel coordinates, the color depth, and the display width to provide a byte code address. In one embodiment, the byte code address is a 16 bit binary number.

The method then advances to operation 236 where at least one least significant bit of the byte code address is selected as a byte enable. In one embodiment, the two least significant bits are selected as the byte enable as illustrated in FIGS. 5-10. In another embodiment, circuitry configured to execute the method operations described here can truncate the 16 bit byte code address to select the byte enable. The method then proceeds to operation 238 where the byte enable is associated with a word line. In one embodiment, where the data bus is a 32 bit data bus, the two least significant bits identify which of the four bytes data associated with the pixel coordinates is addressed to as described with reference to FIGS. 5-10.

The method then moves to operation 240 where a determination is made for the number of bytes of the word line for storing data associated with the pixel address. In one embodiment, a color depth is used to determine the number of bytes for storing the data associated with the pixel address. As mentioned above, the color depth provides the number of bytes per pixel. Thus, where the number of bytes is greater than one, the number of bytes for the data will also be greater than one. That is, for two bytes per pixel (16 bpp), two bytes of the double word line are selected to store the data. For four bytes per pixel (32 bpp), four bytes of the double word line are selected to store the data. In one embodiment, where three bytes per pixel (24 bpp) data is being stored, all 4 bytes of the double word line are selected. It should be appreciated that a single word memory could similarly be accommodated by a least significant bit serving as a byte enable. That is, if the byte enable is one logical value, then a first byte of the single word line is selected. Where the byte enable is another logical value then a second byte of the single word line is selected.

In summary, the embodiment described above allow for translating a two dimensional pixel address to a linear memory address. Operations previously performed by software are performed by an integrated circuit configured to execute the functionality described herein. Thus, the computationally intensive conversion processes are offloaded from the CPU to the integrated circuit to improve system performance, especially with respect to handheld electronic devices that have limited resources. Additionally, the equation for performing the translation is based upon multiplication operations.

The above described invention may be practiced with other computer system configurations including hand-held devices, microprocessor systems, microprocessor-based or programmable consumer electronics, minicomputers, mainframe computers and the like. While the invention has been described in relation to the embedded systems of handheld devices, it should be appreciated that the invention may also be used with desktop and laptop computing systems.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A display controller, comprising:
address calculation circuitry configured to receive an X pixel coordinate and a Y pixel coordinate from a central processing unit, the address calculation circuitry configured to translate the X pixel coordinate and the Y pixel coordinate to a linear address associated with a memory in communication with the display controller; and
byte enable calculation circuitry configured to receive the linear address associated with the memory from the address calculation circuitry, the byte enable calculation circuitry configured to enable a position of the linear address associated with the memory according to a color depth provided to the byte enable calculation circuitry.

2. The display controller of claim 1, further including:
data modification circuitry configured to move pixel data associated with the X pixel coordinate and the Y pixel coordinate to the position of the linear address associated with the memory.

3. The display controller of claim 1, wherein the linear address is a double word line.

4. The display controller of claim 1, wherein the memory is a 32 bit memory.

5. The display controller of claim 1, wherein the display controller is a component of an embedded system for a handheld electronic device.

6. The display controller of claim 1, wherein the color depth is determined by a number of bits associated with each pixel.

7. The display controller of claim 1, wherein the address calculation circuitry translates the X pixel coordinate and the Y pixel coordinate to a byte code address having at least one least significant bit capable of being used as a byte enable.

8. The display controller of claim 7, wherein the byte enable identifies a position within the linear address associated with the memory.

9. The display controller of claim 8, wherein the linear address is a double word line and the position within the linear address is a byte location in the double word line.

10. A device configured to display an image, comprising:
a central processing unit (CPU);
a random access memory (RAM);
a display screen for displaying an image; and
a display controller in communication with the CPU, the RAM and the display
screen; the display controller including,
address calculation circuitry configured to receive an X pixel coordinate and a Y pixel coordinate from the CPU, the address calculation circuitry configured to translate the X pixel coordinate and the Y pixel coordinate to a linear address associated with the RAM; and
byte enable calculation circuitry configured to receive the linear address associated with the RAM from the address calculation circuitry, the byte enable calculation circuitry configured to enable a position of the linear address associated with the RAM according to a color depth provided to the byte enable calculation circuitry, wherein the position is configured to store data associated with the image.

11. The display controller of claim 10, wherein the linear address is a double word line.

12. The display controller of claim 10, wherein the color depth is determined by a number of bits associated with each pixel.

13. The display controller of claim 10, wherein the address calculation circuitry translates the X pixel coordinate and the Y pixel coordinate to a byte code address having at least one least significant bit capable of being used as a byte enable.

14. The display controller of claim 13, wherein the byte enable identifies a position within the linear address associated with the memory.

15. The display controller of claim 14, wherein the linear address is a double word line and the position within the linear address is a byte location in the double word line.

16. A method for translating two dimensional address coordinates for a display to a linear address memory system, comprising:
converting a two dimensional pixel address to a byte code address;
identifying at least one least significant bit of the byte code address as a byte enable; and
associating the byte enable with a position of a linear address of memory.

17. The method of claim 16, wherein the byte code address is a 16 bit binary number.

18. The method of claim 16, wherein the method operation of associating the byte enable to a position of a linear address of memory includes,
defining a color depth indicating the position of the linear address of memory.

19. The method of claim 16, wherein the method operation of converting a two dimensional pixel address to a byte code address includes,
defining a binary number as the byte code address.

20. The method of claim 19, wherein the binary number is a sixteen bit binary number.

21. The method of claim 16, further including,
defining a formula adding an X coordinate and a Y coordinate associated with the two dimensional address, the Y coordinate being multiplied by a display width prior to being added to the X coordinate, the formula yielding a decimal number; and
converting the decimal number to a binary number.

22. The method of claim 16, further including,
defining a formula having an X coordinate and a Y coordinate associated with the two dimensional address as variables; and
multiplying the formula by a color depth to generate a result, the result used to convert the X coordinate and the Y coordinate to a byte address.

23. The method of claim 16, wherein each position of the linear memory address defines a byte location in a double word line.

24. A method for converting pixel coordinates to a linear byte address, comprising:
supplying a two dimensional pixel address having an X coordinate and a Y coordinate;
associating a color depth with the two dimensional pixel address;
transforming the two dimensional pixel address to a byte code address;
selecting at least one least significant bit of the byte code address as a byte enable;
associating the byte enable with a location in a word line; and
determining a number of bytes of the word line to store data associated with the pixel address.

25. The method of claim 24, wherein the method operation of determining a number of bytes of the word line to store data associated with the pixel address includes,
selecting the number of bytes based upon the color depth.

26. The method of claim 24, wherein the method operation of transforming the two dimensional pixel address to a byte code address includes,
converting the two dimensional pixel address to a binary number.

27. The method of claim 26, wherein the binary number is a 16 bit binary number.

28. The method of claim 26, wherein the byte enable consists of a first least significant bit and a second least significant bit.

29. The method of claim 24, wherein the word line is a double word line.
